(19) United States
(12) Patent Application Publication
(10) Pub. No.: US 2012/0060146 A1
(43) Pub. Date: Mar. 8, 2012

(54) Automatic Application Tuning

(75) Inventor: Slade S. MAURER, San Francisco, CA (US)

(73) Assignee: Google Inc., Mountain View, CA (US)

(21) Appl. No.: 12/875,683

(22) Filed: Sep. 3, 2010

(51) Int. Cl. G06F 9/44

(52) U.S. Cl. 717/110; 717/128

(57) ABSTRACT

According to an embodiment, a method of automatically tuning a software application is provided. The method includes modifying the execution of the software application using a first parameter, and scoring the first parameter based on a log value from the software application and an improvement goal. Next, the first parameter, the score of the first parameter and the log value is stored in a data store. The first parameter is then combined with a selected parameter retrieved from the data store, resulting in a second parameter. The listed steps are repeated until a criteria is met, and when the criteria is met, tuning results are generated based on the parameters, the log values and the improvement goal.

### FIELD

The present application generally relates to software application optimization and tuning.

### BACKGROUND

Over the years, software applications have continued to increase in complexity. One key point of operational complexity exists because of myriad different settings controlling many important aspects of program operation, e.g., caching, memory usage, security, external resource use, etc. Settings for modern software applications generally cannot just be set once; the evolution of a software application over time—e.g., development, testing, deployment, popularity, scaling up—require that complex settings be tuned periodically.

In many firms, current developer workload is very high, and optimizing settings tends to be overlooked until problems occur. Conventional approaches, when they are taken at all, generally range from simply adding more resources to reduce setting-caused bottlenecks to manually adjusting individual settings based on guesses and experience.

Conventional approaches to tuning application settings also are not comprehensively directed to all of the settings available for a particular application. Lack of time, experience and information all contribute to limit both the frequency and scope of conventional application tuning.

### BRIEF SUMMARY

Embodiments described herein relate to providing a method, apparatus and computer program product for automatically tuning a software application. According to an embodiment, a method of automatically tuning a software application is provided. The method may include modifying the execution of the software application using a first parameter, and scoring the first parameter based on a log value from the software application and an improvement goal. Next, the first parameter, the score of the first parameter and the log value is stored in a data store. The first parameter is then combined with a selected parameter retrieved from the data store, resulting in a second parameter. The listed steps are repeated until a criteria is met, and when the criteria is met, tuning results are generated based on the parameters, the log values and the improvement goal.

According to another embodiment, an apparatus for automatically tuning a software application includes an extractor configured to receive log values from the operation of the software application, the operation of the software application being affected by a first parameter set, a data store configured to store the received log values and the first parameter set, and a fitness determiner configured to score the first parameter set based on the received log values and a goal. The apparatus may further include a hypothesizer configured to retrieve a selected parameter set from the data store and combine the first parameter set with the selected parameter set to produce a second parameter set and a terminator configured to determine, based on a criteria, whether to modify the execution of the software application using the second parameter set and repeat operations of the extractor, data store and fitness determiner for the second data set. When the operations are not repeated, a reporter is configured to generate tuning results based on the parameters, the log values and the goal.

Further features and advantages, as well as the structure and operation of various embodiments are described in detail below with reference to the accompanying drawings.

### BRIEF DESCRIPTION OF THE FIGURES

Embodiments of the invention are described with reference to the accompanying drawings. In the drawings, like reference numbers may indicate identical or functionally similar elements. The drawing in which an element first appears is generally indicated by the left-most digit in the corresponding reference number.

FIG. 1A is a block diagram depicting a software application and a tuner, according to an embodiment.

FIG. 1B is a block diagram depicting a software application having multiple instances and a tuner, according to an embodiment.

FIG. 2 is a block diagram depicting a more detailed view of a tuner and an experiment database, according to an embodiment.

FIG. 3A is a block diagram depicting a more detailed view of a hypothesizer and an experiment database, according to an embodiment.

FIG. 3B is a table illustrating a combination of parameter sets, according to an embodiment.

FIG. 4 is a block diagram depicting a tuner and a Java Virtual Machine (JVM), according to an embodiment.

FIG. 5 shows a flowchart illustrating a method of automatically tuning a software application according to an embodiment of the invention.

FIG. 6 depicts a sample computer system that may be used to implement an embodiment.

### DETAILED DESCRIPTION OF EMBODIMENTS

The following detailed description refers to the accompanying drawings that illustrate exemplary embodiments. Embodiments described herein relate to providing systems and methods for protecting connectivity in a network. Other embodiments are possible, and modifications can be made to the embodiments within the spirit and scope of this description. Therefore, the detailed description is not meant to limit the embodiments described below.

It would be apparent to one of skill in the relevant art that the embodiments described below can be implemented in many different embodiments of software, hardware, firmware, and/or the entities illustrated in the figures. Any actual software code with the specialized control of hardware to implement embodiments is not limiting of this description. Thus, the operational behavior of embodiments will be described with the understanding that modifications and variations of the embodiments are possible, given the level of detail presented herein.

### Overview

Generally speaking, some embodiments described herein automatically tune parameters associated with the execution of a software application. As noted above, as requirements for deployed software applications change, maintaining optimally configured parameter settings can be difficult. An embodiment described herein performs an “experiment,” by using experimental parameter values with an operating application. An extractor extracts results from the application, and a hypothesizer reviews the extracted results. Based on the results and a tuning goal, the hypothesizer selects new parameter values and the cycle is performed again. Once the possible experiments have been performed or a particular result is achieved, the iterative cycle is terminated and results are generated.

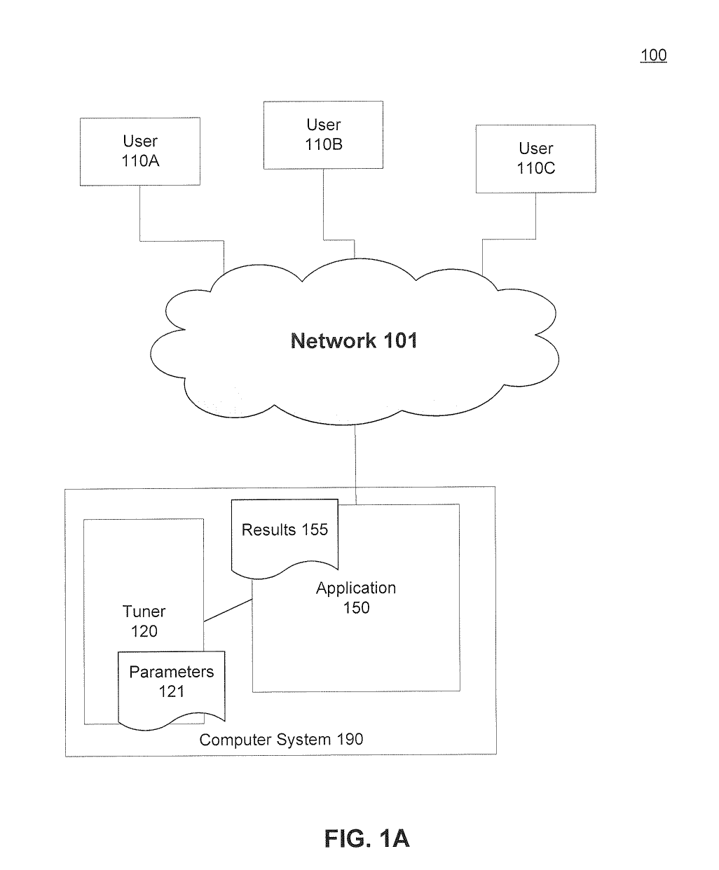

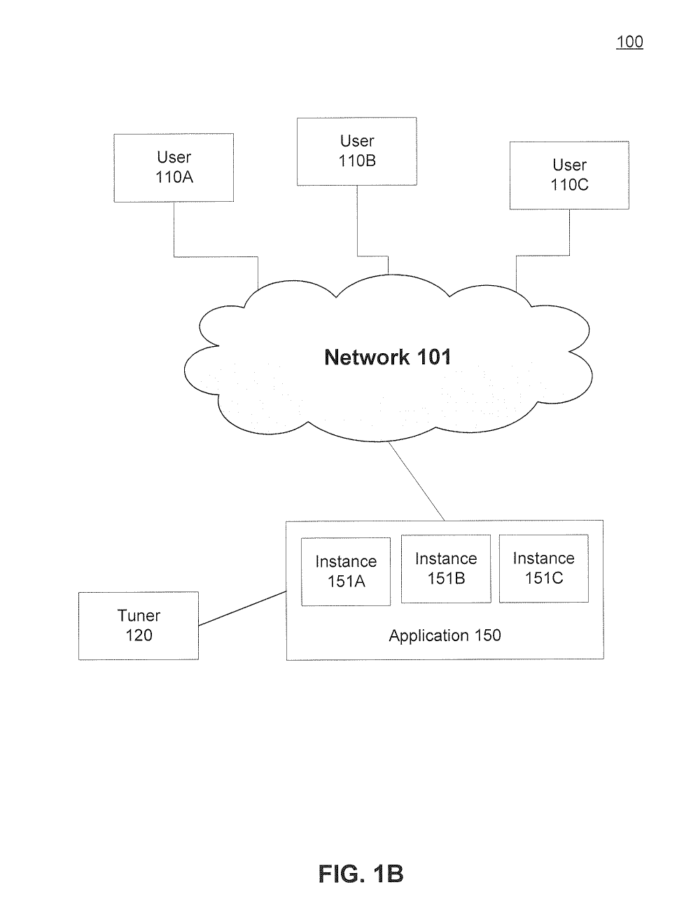

FIG. 1A depicts a block diagram of system 100 according to an embodiment, such system having users 110A-C, network 101 and computer system 190. Computer system 190 is depicted having application 150 and tuner 120. In an embodiment, application 150 is a software application executing on computer system 190.

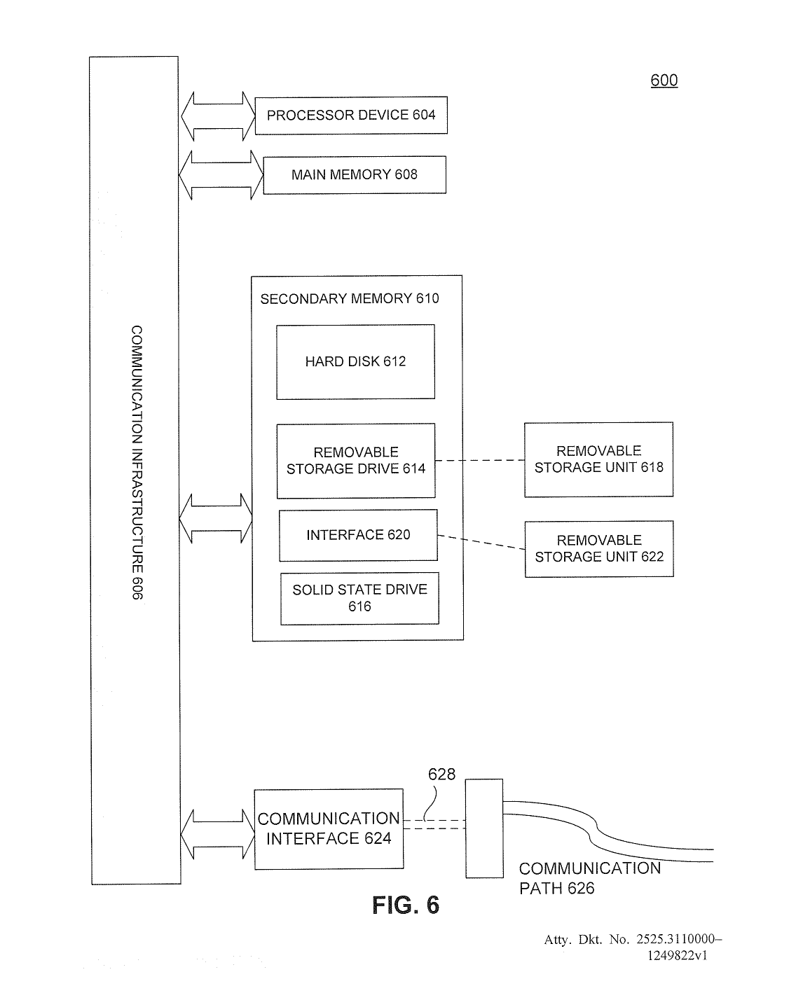

Each of these system components depicted in FIGS. 1-6 and discussed herein may be executed on any type of computing device including, but not limited to, a computer, workstation, distributed computing system, embedded system, stand-alone electronic device, networked device, mobile device, rack server, one or more load-balanced redundant servers, server farm, television, or other type of computer system. It is important to note that embodiments of all of the components, applications, virtual machines, etc., described herein can be executed using one or more computing devices, with spanning/distributed functions. Additional discussion and illustration of example computing devices is made with reference to FIG. 6 below.

Network 101 may be any network or combination of networks that can carry data communication. Such network 101 can include, but is not limited to, a local area network, medium area network, and/or wide area network such as the Internet. Network 101 can support protocols and technology including, but not limited to, World Wide Web protocols and/or services. Intermediate web servers, gateways, or other servers may be provided between components of system 100 depending upon a particular application or environment. Generally speaking, some of the embodiments discussed herein are network-based applications, using network 101 to distribute functions to users 110A-C, for example. It is important to note that some functions described with embodiments herein do not require network 101.

As used in the description of some embodiments herein, a software application, e.g., application 150, can be any type of computer program designed to perform specific tasks. In some embodiments, application 150 is server-software designed to perform tasks for users over network 101, such software having multiple complex parameters and/or settings that configure the execution, performance, and/or efficiency of the application. In these complex embodiments, as noted in the background above, periodic tuning of application 150 parameters can have significant benefits.

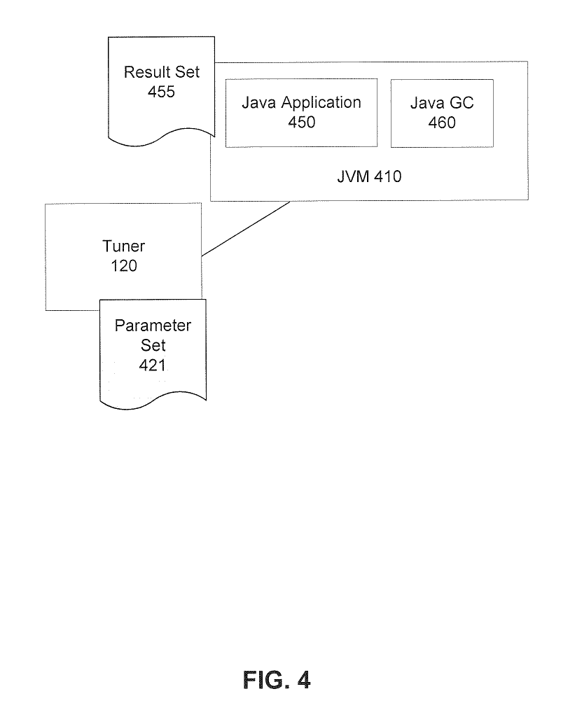

As used in the description of some embodiments herein, “application parameters” can broadly refer to any parameter that can change the operation of application 150. This definition also includes parameters that can govern the operation of the software language environment in which application 150 is being operated, e.g., the discussion of Java Virtual Machine (JVM) parameters with respect to FIG. 4 below.

For example, application 150 can be a Java application. As would be appreciated by one having skill in the relevant art(s), with access to the teachings herein, a Java application can execute within a Java Virtual Machine. When executing an application, a JVM has multiple application parameters that can change the operation of applications running in the JVM.

The following non-limiting, illustrative list of steps S1-S9 broadly describes the setup and operation of an embodiment of tuner 120:

S1. Application 150 is assessed, and at least one goal associated with application execution is determined. For example, if application 150 is a high-performance application that requires a quick response, improved latency can be selected as a goal. As is discussed further below, in an embodiment, multiple, ranked goals can be selected at this step.

S2. Based on the one or more goals selected with S1 above, a result 155 is selected that measures the progress toward the goal. Continuing the above example, a result 155 that can measure latency in an application is the “pause time” of the application. In an embodiment, multiple, ranked results 155 can also be selected, the combination of which can measure progress toward the one or more goals. For example, in addition to selecting “pause time” an embodiment can select “throughput”—these results being ranked in order of significance toward the goal. Calculations, weighting and other combing techniques can be used by an embodiment to measure multiple results 155 from application 150.

S3. Application 150 has a plurality of parameters 121, such parameters 121 affecting the operation of application 150. Based on the characteristics of application 150 and potentially, result 155, at least one of the plurality of parameters 121 is selected for use by tuner 120 in an experiment. Continuing the example above, whether to perform serial garbage collection in a virtual machine is an example parameter 121 that can affect the pause time result 155 noted in S2.

S4. Based on an analysis of application 150 and other factors, an initial value is selected for the selected parameter 121. In this example, serial garbage collection is selected. In an embodiment, this initial value for parameter 121 combined with the selected result 155 to be monitored can be termed an “experiment.” In an embodiment, this initial value is termed an “initial experimental population.”

S5. To perform the “experiment” noted in S4, application 150 is started using parameter 121. Different approaches to conducting this experiment can be taken by embodiments. One approach is to use a quality assurance (QA) test system, and another approach is to use a production system. As would be appreciated by one having skill in the relevant art(s), given the description herein, to receive a useful result 155—e.g., one that could be generalized to a production system—it is useful to execute this experiment using a realistic load/type of users. In this example, a production system is used. One way of characterizing the useful results sought by an embodiment is terming the useful results “real world data.” Another example approach to the test system versus production system question is discussed with FIG. 1B below.

S6. The experiment begins and results are gathered over a period of time. As with the realistic load/users factor noted above, the selected period could be selected so as to simulate a production system. In the example embodiment, application 150 exhibits diurnally cyclical traffic throughout the day and thus requires at least 24 hours of operation to generate useful results. Other embodiments could have longer or shorter selected periods based on their usage characteristics.

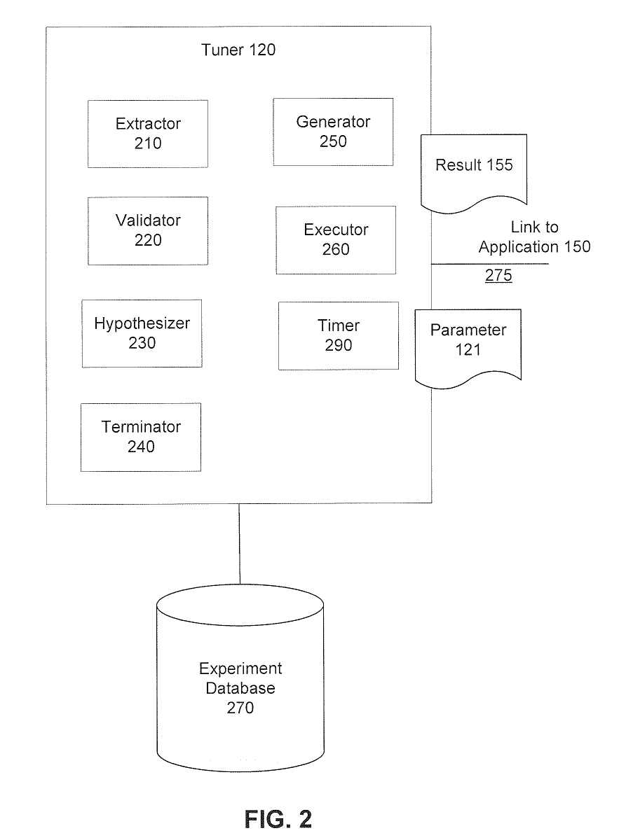

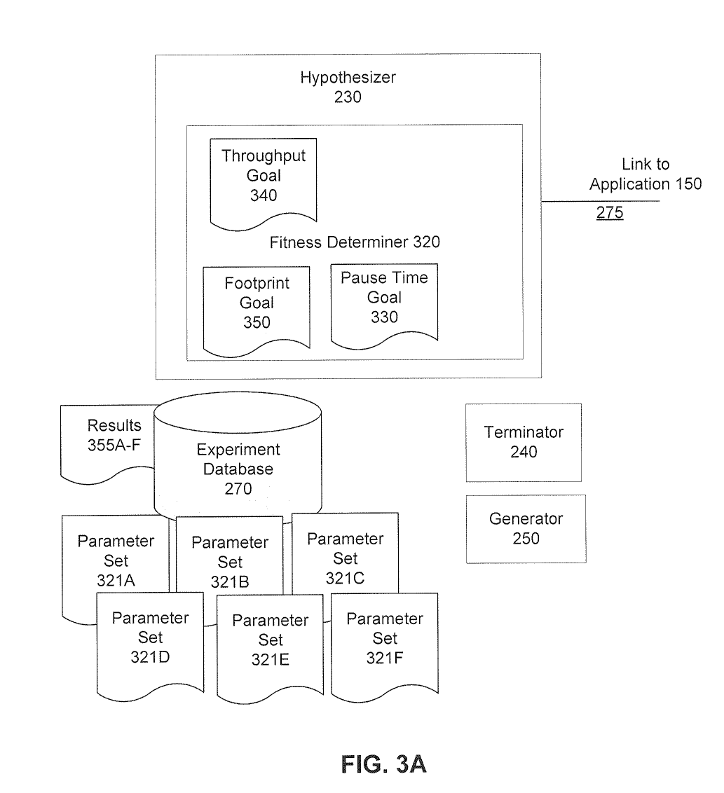

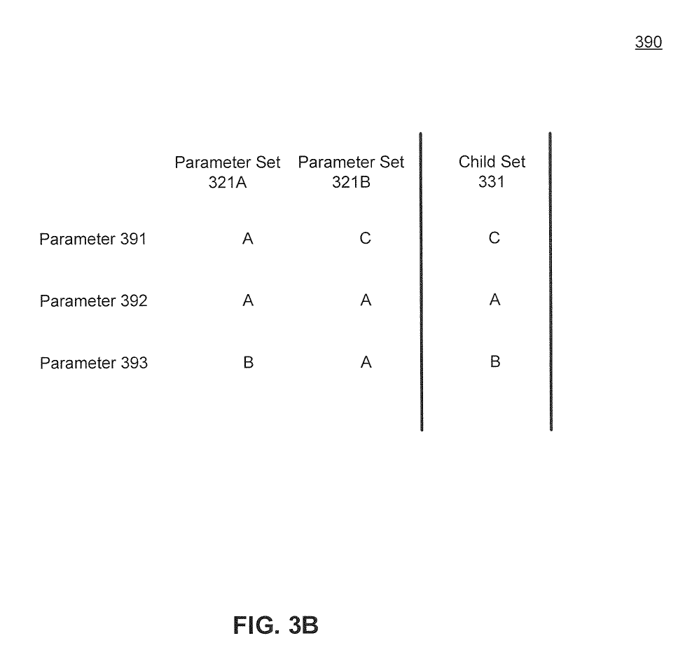

S7. Once the experiment is completed and result 155 is collected by tuner 120, tuner 120 analyzes the collected result 155. In different embodiments, this analysis can involve different considerations and approaches. One approach is described further with FIGS. 2-3 below.

S8. Based on the analysis of S7, tuner 120 either formulates a new experiment (by selecting a new value for parameter 121) or terminates the iterative cycle. In different embodiments, this termination can be for different reasons, including that all of the different available parameter values have been tried, or that improvement toward the goal is determined not to be likely with further experimentation.

S9. If a new experiment is formed by tuner 120, then the process begins again at S6 above. If the process is terminated by tuner 120, then a parameter value for parameter 121 is selected that best achieved the goal selected in S1.

This example of items S1-S9 is illustrative and not intended to limit embodiments. As would be apparent to a person skilled in the art given this description, all the steps above may not be performed by embodiments, steps may be performed in a different order, and additional steps may be added.

Items S1-S9 are intended illustrate a broad description of the operation of some embodiments. FIGS. 1B-5 described below add additional detail to the operation of different items S1-S9. Generally speaking: FIG. 1B adds additional exemplary detail to the performance of S5, FIG. 2 adds exemplary detail to S5-S9, FIG. 3 adds exemplary detail to S7-S8, FIG. 4 describes an applied example using the details discussed with FIGS. 1B-3 and FIG. 5 depicts a flowchart having portions of S1-S9, according to an embodiment.

FIG. 1B depicts a more detailed block diagram of system 100, showing application 150 as having three instances 151A-C. In an embodiment, as noted with item S5 above, application 150 can execute on a QA system, such system being used for internal testing and not connected an external environment. In an alternative embodiment, as noted with item S5, in order to better satisfy the improvement goals for production application systems, application 150 is executed in a production environment, having potentially thousands of users, e.g., users 110A-C.

One additional approach taken to testing application 150, according to an embodiment, is to have multiple instances 151A-C of application 150, and only use tuner 120 on a portion of the available instances. For example, tuner 120 may only be testing parameter sets on instance 151A, while allowing instances 151B-C to execute with the currently active production parameters. In this example, instance 151A may be termed a “canary” or a “canary instance.” This approach can allow for testing that produces useful data while not risking the operating of the entire production system.

FIG. 2 depicts a detailed block diagram of tuner 120 according to an embodiment, such component having extractor 210, validator 220, hypothesizer 230, generator 250, executor 260, timer 290 and terminator 240. Result 155 and parameter 121 are shown, along with tuner 120 depicted as coupled to experiment database 270, with a link 275 to application 150 (not shown).

### Executor

In an embodiment noted in item S5 above, the experiment is started using an initial value for parameter 121. In an embodiment, executor 260 starts the experiment in the QA environment or in production on a canary. It is important to note that, as noted above, each experiment can use multiple parameters 121 and collect and/or receive multiple results 155, and also that multiple experiments can be run by one or more tuners 120 simultaneously on the same or different applications 150.

### Extractor

As noted in item S6 above, once an experiment begins, results 155 may be gathered over a period of time. In an embodiment, results 155 are gathered by extractor 210 (extractor object) via link 275 to application 150. One approach taken by an embodiment of extractor 210 is to scrape, parse and collate the logs of application 150, with application 150 configured to store results 155 in such logs. Another approach taken by an embodiment is to have application 150 send result 155 to extractor 210. In an embodiment, result 155 is stored for later retrieval. One approach to storing result 155 is to use experiment database 270. In embodiments, any result generated by application 150—regardless of how it is transferred to extractor 210—is termed a “log value.” Log values are also equivalent to results as discussed with respect to some embodiments herein.

In an embodiment, the extractor processing described above is initiated by the operation of timer 290 within tuner 120. In an embodiment, timer 290 was started by executor 260 when the experiment was commenced. The expiration of timer 290 indicates the end of the experimental period (discussed with respect to item S6 above) and the beginning of the data extraction phase to be performed by extractor 210.

In an embodiment, all of the data present in the application 150 logs are recorded in as much detail as possible in experiment database 270. This provides a rich data set for tuner 120 to use in later steps.

In an embodiment, validator 220 determines if the result 155 data is useful for analysis by later stages. Different criteria can be used by some embodiments to determine result 155 validity. For example, if the operation of application 150 was prematurely terminated due to a bad parameter value or for other reasons, this data can be detected and removed from experiment database 270 at this stage.

### Hypothesizer

In an embodiment, after experimental validation performed by validator 220, hypothesizer 230 analyzes results 155 stored in experiment database 270. Generally speaking, results 155 are used by hypothesizer 230 to produce a new experiment to run. One approach taken by an embodiment of hypothesizer 230 is to create the “best of breed” of experiment parameters 121 by scoring results 155 of completed experiments and generating new parameters 121 for new experiments.

FIG. 3A depicts a detailed view an embodiment of experiment database 270, terminator 240 and hypothesizer 230, such hypothesizer 230 having fitness determiner 320, footprint goal 350, throughput goal 340 and pause time goal 330. Experiment database 270 is depicted as having parameter sets 321A-F therein—such sets stored, in an embodiment by extractor 210 from FIG. 2.

In an embodiment, fitness determiner 320 analyzes results 355A-F resulting from parameter sets 321A-F against selected goals 330, 340, 350. Three example optimization goals used by some embodiments include: pause time 330, application throughput 340 and memory footprint 350. These example optimization goals are discussed below with the example of FIG. 4, and also can be applied generally to other application tuning problems.

In an embodiment, fitness determiner 320 scores parameter sets 321A-F (experiment data) extracted by extractor 210 and validated by validator 220. In an embodiment, the results/parameter set of the present experiment (e.g., 355A/321A) can be compared to one or more previous experiments, e.g., 355B-F/321B-F. As noted above, if multiple result values are determined to be relevant, combinations can be analyzed, and goals 330, 340, 350 can be ranked in order of importance.

The scoring approach taken by fitness determiner 320 is configurable and is specific to the application type and/or goal being tuned. As noted above in item S1, different goals (optimization goals) can be selected for use in evaluating parameter sets 321A-F.

Example Fitness Determiner Scoring Approach

The following example is non-limiting and intended to illustrate a customized fitness function, used by an embodiment of fitness determiner 320. In this example, monitored application 150, e.g., a service, generates the following parameter set 321A:

n[p]=avgMinorPauseTime=109

n[i]=avgMinorIntervalTime=22994

j[p]=avgMajorPauseTime=6460

j[i]=avgMajorIntervalTime=1170644

An example fitness function can be an algebraic function that, considering the selected optimization goal, uses the performance measurements listed above to produce a score for parameter set 321A. The following is a non-limiting example of a fitness function based on parameter set 321A listed above:

function(n[p],n[i],j[p],j[i])=n[i]/n[p]+j[i]/j[p]

After using the values above in the listed example function, the following score is produced:

22994/109+1170644/6460=210.95+181.21=392.16

The example fitness function score (392.16) can be used to rank parameter set 321A against other parameter sets 321B-F. For example, if parameter set 321B results in a score of 300, an embodiment can determine 321A to be a higher ranked/better parameter set with respect to the selected optimization goal.

In another example, a fitness function can use weights to weight different parameters against each other. Using the above listed example parameter set 321A, if the major pause/interval times (j) are considered twice as important as the minor times (n), the following fitness function could be used by an embodiment:

Wj=2

f(n[p],n[i],j[p],j[i])=n[i]/n[p]+(j[i]/j[p])*Wj)

As would be appreciated by one having skill in the relevant art(s), given the description herein, many different types of fitness functions can be used by some embodiments.

Genetic Algorithm

After fitness determiner 320 analyzes/scores results 355A-F of experiment parameter sets 321A-F, different embodiments of hypothesizer 230 can use different approaches to generate new parameter sets for new experiments. One approach taken by an embodiment uses an evolutionary/genetic approach to combine fitness determiner 320 evaluated parameter settings into new “child” parameter set combinations. Termed differently, hypothesizer 230 can combine and reformulate parameter sets to seek improved results toward selected goals 330, 340, 350.

The following non-limiting, illustrative list of steps G1-G2 broadly describes the setup and operation of an embodiment of hypothesizer 230 using an evolutionary/genetic algorithm.

G1. Hypothesizer 230 selects parameter sets from available parameter sets 321A-F, then crosses (or combines) the population, favoring the experiments with the highest scores for crossing/combining. In an example where hypothesizer 230 has six parameter sets 321A-F to choose from, the two with the highest scores can be chosen for crossing, e.g., 321A-B. In this example, the third through sixth ranked parameter sets 321C-F are not selected for crossing/combining. In another embodiment, any portion of the available parameter sets 321A-F can be chosen for crossing.

G2. FIG. 3B depicts an embodiment of crossing process 390, such process combining parameter set 321A and 321B to form child set 331. Each parameter set 321A-B and child set 331, has parameters 391, 392 and 393. In an embodiment, a random/pseudorandom result generator is used to selectively choose a value for child set 331 for each parameter 391, 392 and 393 from parameter sets 321A-B. In the table depicted on FIG. 3B, for example, child set 331 received its parameter 391 (“C”) from parameter set 321B, not from parameter set 321A. The remainder of the parameters 392, 393 of child set 331 were selected in a similar fashion. In an embodiment, each “parent” parameter set 321A-B can be termed a “chromosome.”

Other Techniques

Some embodiments can use different learning techniques to modify the operation of embodiments. Items T1-T3 below are intended to be a non-limiting list of exemplary learning techniques used to alter the operation of some embodiments described herein. One having skill in the relevant art(s), given the description herein, will appreciate the operation of T1-T3 and how the approaches can apply to some embodiments:

T1. Supervised learning.

T2. Semi-supervised learning.

T3. Unsupervised learning.

In one use, the learning techniques T1-T3 can be used to alter the operation of an embodiment by improving the performance of the embodiment. For example, before the performance of an experiment, a learning technique (e.g., T1-T3) can be used to predict how likely it is that a parameter set (chromosome) will perform well in the experiment. In an embodiment, such success predictions can be used to reduce the number of parameter sets that need to be tested, and therefore reduce the time for the embodiment to find a solution. As would be appreciated by one having skill in the relevant art(s), given the description herein, other approaches to reducing the number of parameter sets required for testing can be used.

### Generator

In an embodiment, using the approach of G1-G2, a new generation of experiment parameter sets are created, and in an embodiment, these new selected parameter sets (child set 331) are stored in experiment database 270. In an embodiment, returning to FIG. 3A, generator 250 queries experiment database 270 to retrieve the new selected parameter set from hypothesizer 230.

### Terminator

Different embodiments can terminate the above tuner 120 process at different points based on a determination that continued iterative experiments would not have benefit. Terminator 240, as noted above in item S8, in different embodiments, can terminate the experiment process described above for different reasons. Termination reasons include that all of the different available parameter values have been tried, or improvement toward the goal is estimated not to be likely with further experimentation.

One way to estimate whether further experiments could lead to better results involves the concept of diminishing returns. For example, an embodiment of fitness determiner 320 and terminator 240 could determine that the improvement in results 355 from one experiment to the next was less than a threshold value—either once or over a period of time. Alternatively, results 355 could be diminished in value—either once or over time. In some embodiments, the combination of assessing results over time, and the random combination of parameters in parameter sets using the genetic algorithm described above can beneficially avoid the “local minima” problem (where results are temporarily diminished in value, then resume improvement).

Generating Results after Termination

As noted in item S1 above, before the operation of tuner 120, one or more goals are selected that are associated with the operation of application 150. After termination, different embodiments have determined one or more parameter sets that, when deployed in production on the application 150, can lead to improved performance toward the one or more selected improvement goals. An embodiment generates a report that includes a list of the parameter names and values for each parameter in one or more determined final parameter sets.

As would be appreciated by one having skill in the relevant art(s), given the description herein, generated parameter set results can be memorialized in many different ways by embodiments. The following non limiting, illustrative list of items P1-P5 lists examples of the form of parameter reports generated by embodiments:

P1. Electronically written to a log file

P2. An electronic mail sent to a software application administrator.

P3. Parameter sets can be created and automatically deployed to a production environment.

P4. Parameter sets can be created and automatically deployed to an additional QA environment for further testing.

P5. Parameter sets can be stored in a database.

As would be appreciated by one having skill in the relevant art(s), given the description herein, additional approaches exist for storing/using/reporting results generated by embodiments.

Returning to example application 150, if a selected goal is an improvement in application latency, then, after the termination of the iterative processes described above, a parameter set is generated that lists the parameter sets that have shown to have the best improvement in the latency of application 150. As noted with P2 above, these sets for example, can be emailed to an administrator responsible for the operation of application 150.

### Example: Tuning Java Garbage Collection

FIG. 4 depicts an embodiment with JVM 410 and tuner 120. JVM 410 is depicted having Java application 450 and Java Garbage Collector (Java GC) 460, and tuner 120 is depicted as having parameter set 421. In this example, Java application 450 is running inside JVM 410, with Java GC cleaning up resource use, as would be appreciated by one having skill in the relevant art(s).

As introduced in the background section above, to maintain performance, deployed software applications require changes to key settings over time. For example, with respect to Java Application 450, the code base, Java Development Kit (JDK) and supporting libraries all change over time. For this Java Application 450 example, as with many applications, workload, performance profiles and the relative performance of various external components (hardware and software) upon which it depends, change as well. This example focuses on Java garbage collector (GC) 460 settings as an area when an embodiment can be applied to perform automatic tuning. In this section, for convenience, all of the processes described above are not repeated, rather areas that are specific to this JVM 410 example are discussed: tuning goals, fitness determiner, JVM parameters, extractor and tuner 120 command line arguments.

### Example Fitness Determiner

As noted above with respect to FIG. 2 and list item S1, and FIG. 3A and the discussion of fitness determiner 320, in this example a goal is selected that is designed to achieve a desired result. In this example, to improve the operation of Java application 450, JVM GC 460 experiments are configured for three optimization goals related to GC: pause time, throughput and memory footprint. These goals are shown in FIG. 3 (330-350) and listed below as non-limiting list G1-G3:

G1. Pause Time Goal: As noted above, in this example, the most important aspect of tuning Java GC 460 settings of JVM 410 revolves around the amount of time Java application 450 is paused. Java GC 460 pause time generally causes threads to halt during garbage collection and is directly related to application latency, which can be of primary importance to application execution. In an embodiment, this is the most important goal.

G2. Throughput Goal: Java application 450 throughput is proportional to the amount of CPU processing time devoted to useful work and is generally inversely proportional to JVM GC 460 pause time (G1). Additionally, when a concurrent JVM GC 460 is used (not shown) then the concurrent JVM GC thread(s) potentially take up CPU resources from the application threads. In an embodiment, because this throughput can use CPU resources, it is the second most important goal.

G3. Memory Footprint Goal: The amount of memory devoted to Java application 450 is the termed the “memory footprint” and generally should be minimized to avoid resource waste. In an embodiment, this is the least important goal as compared to goals G1-G2 listed above.

Goals G1-G3 are non-limiting and intended illustrate example goals for the operation of some embodiments. As would be appreciated by one having skill in the relevant art(s), given the description herein, a wide variety of other goals can be use by embodiments.

### Example JVM Parameters

Below is an example of different JVM 410 settings that can be used in this example. In an embodiment, one JVM setting from the list below is incremented or decremented by a selected amount per experiment. In another embodiment, multiple settings can be combined together into parameter set 421.

1. Collectors
1. Serial
   1. -XX:+UseSerialGC
2. Parallel
   1. -XX:+UseParallelGC
   2. -XX:+UseParallelOldGC
   3. -XX:ParalleGCThreads=<N>
3. Concurrent
   1. -XX:+UseConcMarkSweepGC
   2. -XX:CMSInitiatingOccupancyFraction=<N>
   3. -XX:+CMSlncrementalMode
   4. -XX:+CMSlncrementalPacing
   5. -XX:CMSIncrementalDutyCycle=<N>
   6. -XX:CMSIncrementalDutyCycleMin=<N>
   7. -XX:CMSIncrementalSafetyFactor=<N>
   8. -XX:CMSIncrementalOffset=<N>
   9. -XX:CMSExpAvgFactor=<N>

2. Heap
1. -Xms<min> and above by -Xm×<max>
2. -XX:MinHeapFreeRatio=<minimum>
3. -XX:MaxHeapFreeRatio=<maximum>

3. Generations
1. -XX:NewRatio=<N>
2. -XX:SurvivorRatio=<N>

4. Ergonomics
1. -XX:MaxGCPauseMillis=<N>
2. -XX:GCTimeRatio=<N>
3. -XX:YoungGenerationSizelncrement=<Y>
4. -XX:TenuredGenerationSizeIncrement=<T>
5. -XX:AdaptiveSizeDecrementScaleFactor=<D>

One having skill in the relevant art(s), given the description herein, will appreciate the syntax of the JVM parameters above, and that embodiments can generate variations of the above parameter strings for use as parameters with JVM 410.

### Example Extractor

In an embodiment, extractor 210 in tuner 120 gathers different Java GC 460 statistics. In this example, different statistics that can be collected by extractor 210 include: JVM 410 memory footprint, class instantiation parameters and sizing, and, with Java GC 460, collection statistics. In an embodiment, the statistics available from Java GC 460 cover a wide amount of GC statistics in a time series aggregate form. In another embodiment, additional formats of data are available and usable.

### Command Line Arguments

Continuing with the JVM 410 example, an embodiment of tuner 120 applied to the JVM 410 example, and other applications, can accept a number of different command line arguments, commands executed at a terminal by an administrator. The list of commands below is intended to be non-limiting, and to illustrate the different types of commands and settings that can be used by some embodiments:

In different embodiments, some of the commands below are required and some are optional.

### Required

1. --system_user <NAME>
1. The name of the system user used to run experiments

2. --system_cell <NAME>
1. the name of the system cell to run the experiments

3. --system job <NAME>
1. The name of the system job these tasks run in

4. --concurrent experiments <NUMBER>
1. The maximum number of experiments allowed to run at the same time

5. --experiment_duration <MINUTES>
1. How long in minutes the experiment must run before collecting results

### Optional

1. --verbose
1. produce verbose logs to STDOUT

2. --fitness_function <OTHER FUNCTION>
1. Override the default fitness function with OTHER FUNCTION

3. --stop_after <NUMBER>
1. Stop after NUMBER generations

4. --population_size <NUMBER>
1. Override the default size of the population

5. --mutation_rate <NUMBER>
1. Change the mutation rate to NUMBER (number from 0 to 1.0)

6. --number_of_parents <NUMBER>
1. Set the number of parents crossed for the next generation to NUMBER

7. --save_experdb <NAME>
1. Setting this argument causestuner 120 to dump the contents of the Experiment Database incrementally and upon exit to NAME

8. --load_experdb <NAME>
1. Setting this argument causes JTune to load the Experiment Database NAME and continue processing from that state

In an embodiment, command line arguments can be used to modify application behavior. Embodiments can accept command line arguments from different sources, including other related applications and application/system administrators.

### Method 500

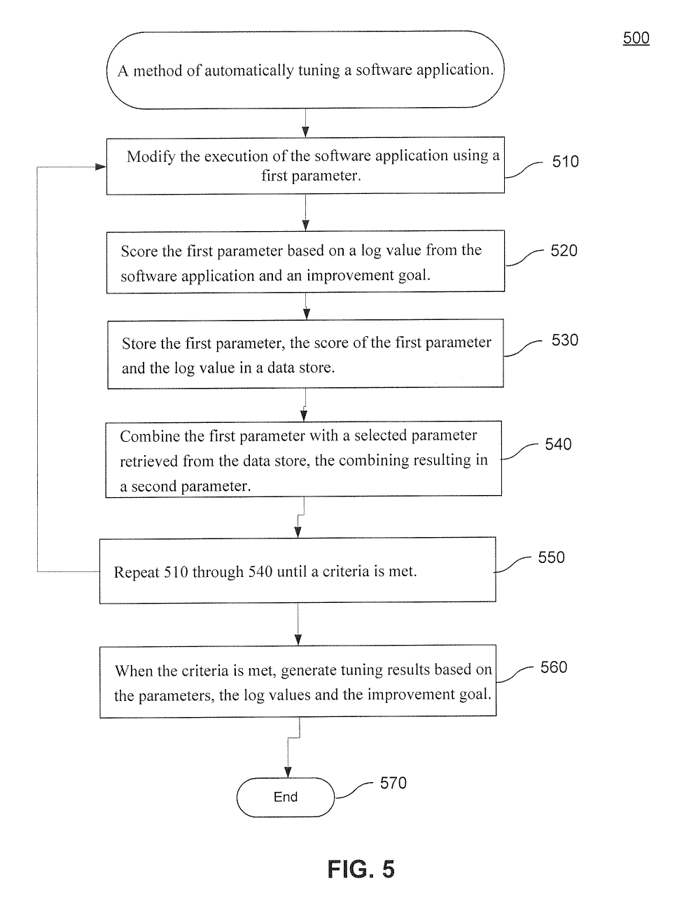

FIG. 5 illustrates a more detailed view of how embodiments described herein may interact with other aspects of embodiments. In this example, a method of automatically tuning a software application is shown. Initially, as shown in stage 510 on FIG. 5, the execution of a software application is modified using a first parameter. At stage 520, the first parameter is scored based on a log value from the software application and an improvement goal. At stage 530, the first parameter, the score of the first parameter and the log value are stored in a data store. At stage 540, the first parameter is combined with a selected parameter retrieved from the data store, this combining resulting in a second parameter. At stage 550, stages 510 through 540 are repeated until a criteria is met. If the criteria is met, at stage 560 tuning results are generated based on the parameters, the log values and the improvement goal. After stage 560, the method ends at 570.

### Example Computer System Implementation

FIG. 6 illustrates an example computer system 600 in which embodiments of the present invention, or portions thereof, may be implemented as computer-readable code. For example, FIGS. 1-4 and stages of method 500 of FIG. 5 may be implemented in computer system 600 using hardware, software, firmware, tangible computer readable media having instructions stored thereon, or a combination thereof and may be implemented in one or more computer systems or other processing systems. Hardware, software or any combination of such may embody any of the modules/components in FIGS. 1-4 and any stage in FIG. 5. Users 110A-C and computer system 190 can also be implemented having components of computer system 600.

If programmable logic is used, such logic may execute on a commercially available processing platform or a special purpose device. One of ordinary skill in the art may appreciate that embodiments of the disclosed subject matter can be practiced with various computer system and computer-implemented device configurations, including smartphones, cell phones, mobile phones, tablet PCs, multi-core multiprocessor systems, minicomputers, mainframe computers, computer linked or clustered with distributed functions, as well as pervasive or miniature computers that may be embedded into virtually any device.

For instance, at least one processor device and a memory may be used to implement the above described embodiments. A processor device may be a single processor, a plurality of processors, or combinations thereof. Processor devices may have one or more processor ‘cores.’

Various embodiments of the invention are described in terms of this example computer system 600. After reading this description, it will become apparent to a person skilled in the relevant art how to implement the invention using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 604 may be a special purpose or a general purpose processor device. As will be appreciated by persons skilled in the relevant art, processor device 604 may also be a single processor in a multi-core/multiprocessor system, such system operating alone, or in a cluster of computing devices operating in a cluster or server farm. Processor device 604 is connected to a communication infrastructure 606, for example, a bus, message queue, network or multi-core message-passing scheme.

Computer system 600 also includes a main memory 608, for example, random access memory (RAM), and may also include a secondary memory 610. Secondary memory 610 may include, for example, a hard disk drive 612, removable storage drive 614 and solid state drive 616. Removable storage drive 614 may comprise a floppy disk drive, a magnetic tape drive, an optical disk drive, a flash memory, or the like. The removable storage drive 614 reads from and/or writes to a removable storage unit 618 in a well known manner. Removable storage unit 618 may comprise a floppy disk, magnetic tape, optical disk, etc. which is read by and written to by removable storage drive 614. As will be appreciated by persons skilled in the relevant art, removable storage unit 618 includes a computer usable storage medium having stored therein computer software and/or data.

In alternative implementations, secondary memory 610 may include other similar means for allowing computer programs or other instructions to be loaded into computer system 600. Such means may include, for example, a removable storage unit 622 and an interface 620. Examples of such means may include a program cartridge and cartridge interface (such as that found in video game devices), a removable memory chip (such as an EPROM, or PROM) and associated socket, and other removable storage units 622 and interfaces 620 which allow software and data to be transferred from the removable storage unit 622 to computer system 600.

Computer system 600 may also include a communications interface 624. Communications interface 624 allows software and data to be transferred between computer system 600 and external devices. Communications interface 624 may include a modem, a network interface (such as an Ethernet card), a communications port, a PCMCIA slot and card, or the like. Software and data transferred via communications interface 624 may be in electronic, electromagnetic, optical, or other forms capable of being received by communications interface 624. This data may be provided to communications interface 624 via a communications path 626. Communications path 626 carries the data and may be implemented using wire or cable, fiber optics, a phone line, a cellular phone link, an RF link or other communications channels.

In this document, the terms “computer program medium” and “computer usable medium” are used to generally refer to media such as removable storage unit 618, removable storage unit 622, and a hard disk installed in hard disk drive 612. Computer program medium and computer usable medium may also refer to memories, such as main memory 608 and secondary memory 610, which may be memory semiconductors (e.g., DRAMs, etc.).

Computer programs (also called computer control logic) may be stored in main memory 608 and/or secondary memory 610. Computer programs may also be received via communications interface 624. Such computer programs, when executed, enable computer system 600 to implement the present invention as discussed herein. In particular, the computer programs, when executed, enable processor device 604 to implement the processes of the present invention, such as the stages in the method illustrated by flowchart 500 of FIG. 5 discussed above. Accordingly, such computer programs represent controllers of the computer system 600. Where the invention is implemented using software, the software may be stored in a computer program product and loaded into computer system 600 using removable storage drive 614, interface 620, hard disk drive 612 or communications interface 624.

Embodiments of the invention also may be directed to computer program products comprising software stored on any computer useable medium. Such software, when executed in one or more data processing devices, causes a data processing device(s) to operate as described herein. Embodiments of the invention employ any computer useable or readable medium. Examples of computer useable mediums include, but are not limited to, primary storage devices (e.g., any type of random access memory), secondary storage devices (e.g., hard drives, floppy disks, CD ROMS, ZIP disks, tapes, magnetic storage devices, and optical storage devices, MEMS, nanotechnological storage device, etc.).

### CONCLUSION

Embodiments described herein relate to methods and apparatus for protecting connectivity in a network. The summary and abstract sections may set forth one or more but not all exemplary embodiments of the present invention as contemplated by the inventors, and thus, are not intended to limit the present invention and the claims in any way.

The embodiments herein have been described above with the aid of functional building blocks illustrating the implementation of specified functions and relationships thereof. The boundaries of these functional building blocks have been arbitrarily defined herein for the convenience of the description. Alternate boundaries may be defined so long as the specified functions and relationships thereof are appropriately performed.

The foregoing description of the specific embodiments will so fully reveal the general nature of the invention that others may, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the claims and their equivalents.

What is claimed is:

1. A method of automatically tuning a software application, comprising:
a) modifying execution of the software application using a first parameter;
b) scoring the first parameter based on a log value from the software application and an improvement goal;
c) storing the first parameter, the score of the first parameter and the log value in a data store;
d) combining the first parameter with a selected parameter retrieved from the data store, the combining resulting in a second parameter;
e) repeating (a) through (d) until a criteria is met; and
f) when the criteria is met, generating tuning results based on the parameters, the log values and the improvement goal.

2. The method of claim 1, further comprising before (b), validating the log value.

3. The method of claim 1, wherein (b) comprises scoring the first parameter based on a log value from the software application, a log value from the data store, and the improvement goal.

4. The method of claim 1, wherein the combining is performed using a genetic algorithm.

5. The method of claim 1, wherein the criteria is met when all appropriate parameter values have been used to modify the execution of the software application.

6. The method of claim 1, wherein the criteria is met when, over a period of time, the incremental improvement resulting from applied parameter sets does not exceed a predetermined threshold.

7. The method of claim 1, wherein a parameter can include a combination of application settings.

8. The method of claim 1 wherein the software application is a virtual machine.

9. The method of claim 1, wherein the log value is one of pause time, throughput or memory footprint.

10. The method of claim 1, wherein the improvement goal is reducing application latency.

11. The method of claim 1, wherein the selected parameter retrieved from the data store in (d) is selected based on a score of the parameter.

12. A system to automatically tune a software application, comprising:
an extractor configured to receive log values from an operation of the software application, the operation of the software application being affected by a first parameter set;
a data store configured to store the received log values and the first parameter set;
a fitness determiner, configured to score the first parameter set based on the received log values and a goal;
a hypothesizer configured to retrieve a selected parameter set from the data store and combine the first parameter set with the selected parameter set to produce a second parameter set;
a terminator configured to determine, based on a criteria, whether to modify the execution of the software application using the second parameter set and repeat operations of the extractor, data store and fitness determiner for the second data set; and
a reporter configured to generate tuning results based on the parameters, the log values and the goal.

13. The system of claim 12, further comprising a validator configured to validate the log values after receipt by the extractor.

14. The system of claim 12, wherein the fitness determiner is further configured to score the first parameter set based on the received log values, a goal, and a log value from the data store.

15. The system of claim 12, wherein the hypothesizer is further configured to combine the first parameter set with the selected parameter set to produce a second parameter set based on a genetic algorithm.

16. The system of claim 12, wherein the terminator is further configured to have the criteria met when all appropriate parameter values have been used to modify the execution of the software application.

17. The system of claim 12, wherein the terminator is further configured to have the criteria met when, over a period of time, the incremental improvement resulting from applied parameter sets does not exceed a predetermined threshold.

18. The system of claim 12, wherein a parameter can include a combination of application settings.

19. The system of claim 12, wherein the software application is a virtual machine.

20. The system of claim 12, wherein the goal is reducing application latency.

21. The system of claim 12, wherein the hypothesizer is further configured to select the parameter to be retrieved from the data based on a score of the stored parameter.

22. The system of claim 12, wherein the fitness determiner is further configured to use a supervised or unsupervised learning technique to score each parameter set.

23. A computer-readable medium having computer-executable instructions stored thereon that, when executed by a computing device, cause the computing device to perform a method of automatically tuning a software application, comprising:
a) modifying execution of the software application using a first parameter;
b) scoring the first parameter based on a log value from the software application and an improvement goal;
c) storing the first parameter, the score of the first parameter and the log value in a data store;
d) combining the first parameter with a selected parameter retrieved from the data store, the combining resulting in a second parameter;
e) repeating (a) through (d) until a criteria is met; and
f) when the criteria is met, generating tuning results based on the parameters, the log values and the goal.
